(19) United States
(12) Patent Application Publication
(10) Pub. No.: US 2024/0071116 A1
(43) Pub. Date: Feb. 29, 2024

(54) PROOFREADING SYSTEM AND PROOFREADING METHOD

(71) Applicant: Semiconductor Energy Laboratory Co., Ltd., Atsugi-shi, Kanagawa-ken (JP)

(72) Inventors: Junpei MOMO, Sagamihara (JP); Shoko SAITO, Atsugi (JP)

(21) Appl. No.: 18/038,763

(22) PCT Filed: Dec. 2, 2021
(86) PCT No.: PCT/IB2021/061206

§ 371 Date: May 25, 2023

(30) Foreign Application Priority Data
Dec. 14, 2020 (JP) 2020-206688

(51) Int. Cl. G06V 30/19; G06V 10/82; G06V 30/242

(52) U.S. Cl. CPC G06V 30/19093; G06V 10/82; G06V 30/19147; G06V 30/242

(57) ABSTRACT

A proofreading system that allows a user to easily judge whether or not there is an error in writing or the like. A proofreading method using a comparison image group obtained by dividing a sentence included in a comparison document group into a plurality of first terms and converting the first terms into images is provided. Specifically, first, a sentence included in a designated document is divided into a plurality of second terms, and the appearance frequency in the comparison document group of the plurality of second terms are obtained. Next, the second term with the appearance frequency lower than or equal to a threshold value of the plurality of second terms are imaged to obtain a verification image. After that, similarity degrees between the verification image and comparison images included in the comparison image group are obtained, and the first term represented by the comparison image with the highest similarity degree of the comparison images is presented. The presentation is performed by displaying that the second term represented by the verification image can be an error in writing of the first term represented by the comparison image having a high similarity degree with the verification image.

### TECHNICAL FIELD

One embodiment of the present invention relates to a proofreading system and a proofreading method for a document.

Note that one embodiment of the present invention is not limited to the above technical field. Examples of the technical field of one embodiment of the present invention include a semiconductor device, a display device, a light-emitting device, a power storage device, a memory device, an electronic device, a lighting device, an input device (e.g., a touch sensor), an input/output device (e.g., a touch panel), a method for driving any of them, and a method for manufacturing any of them.

### BACKGROUND ART

In the case of inputting a term to search for the position of the term in the whole document, when an error in writing is included in the document, the same term as the input term is not sometimes searched for. When a term that is intended to represent “system” but includes an error in writing, e.g., “systm”, is written in the document, “systm” is not searched for by inputting “system” as a term to be searched for. Accordingly, when the error can be detected, the error in writing can be corrected or can be searched for with the error taken into consideration; therefore, comprehensiveness of the search can be increased. As a method for detecting an error in writing, a method in which words included in a document to be searched are sorted and similar but different words are displayed as being possibly an error in writing is disclosed (Patent Document 1).

### REFERENCE

### [Patent Document]

[Patent Document 1] PCT International Publication No. 2014/171519

### SUMMARY OF THE INVENTION

### Problems to be Solved by the Invention

Although the user finally judges whether or not the word is an error in writing in the method shown in Patent Document 1 mentioned above, in the case of characters that are difficult for a human to distinguish at a glance, such as “T” (an alphabet) and “T” (a Greek character), it is difficult to determine there is an error in writing. However, for example, “T” (an alphabet) and “T” (a Greek character) are similar in looking but have different character codes, and thus are recognized by a computer as different characters. For this reason, for example, in the case where “T” (a Greek character) is written instead of “T” (an alphabet) that is a correct character, the comprehensiveness of the search is decreased as in the case where there is an error easy to determine at a glance. Therefore, it is preferable that the user can judge whether or not there is an error in writing even in the case of different characters difficult for a human to distinguish at a glance.

An object of one embodiment of the present invention is to provide a proofreading system or a proofreading method that allows the user to easily judge whether or not there is an error in writing or the like. Another object of one embodiment of the present invention is to provide a highly convenient proofreading system or a highly convenient proofreading method. Another object of one embodiment of the present invention is to provide a proofreading system or a proofreading method that can detect an error in writing or the like with high accuracy. Another object of one embodiment of the present invention is to provide a novel proofreading system or a novel proofreading method.

Note that the description of these objects does not preclude the existence of other objects. One embodiment of the present invention does not need to achieve all of these objects. Other objects can be derived from the description of the specification, the drawings, and the claims.

### Means for Solving the Problems

One embodiment of the present invention is a proofreading system including a dividing unit, an appearance frequency obtaining unit, an image generation unit, a similarity degree obtaining unit, and a presentation unit. The dividing unit has a function of dividing a sentence included in a comparison document group into a plurality of first terms, and a function of dividing a sentence included in a designated document into a plurality of second terms. The appearance frequency obtaining unit has a function of obtaining appearance frequencies in the comparison document group of the plurality of second terms. The image generation unit has a function of imaging the first term to obtain a comparison image group. The image generation unit has a function of imaging the second term with the appearance frequency lower than or equal to a threshold value of the plurality of second terms to obtain a verification image. The similarity degree obtaining unit has a function of obtaining similarity degrees between the verification image and comparison images included in the comparison image group. The presentation unit has a function of presenting the first term represented by at least the comparison image with the highest similarity degree of the comparison images.

One embodiment of the present invention is a proofreading system including a dividing unit, an appearance frequency obtaining unit, an image generation unit, a similarity degree obtaining unit, a model arithmetic unit, and a presentation unit. The dividing unit has a function of dividing a sentence included in a comparison document group into a plurality of first terms, and a function of dividing a sentence included in a designated document into a plurality of second terms. The appearance frequency obtaining unit has a function of obtaining appearance frequencies in the comparison document group of the plurality of second terms. The image generation unit has a function of imaging the first term to obtain a comparison image group. The image generation unit has a function of imaging the second term with the appearance frequency lower than or equal to a first threshold value of the plurality of second terms to obtain a verification image. The similarity degree obtaining unit has a function of obtaining similarity degrees between the verification image and comparison images included in the comparison image group. The model arithmetic unit has a function of obtaining a probability that the first term represented by the comparison image with the similarity degree greater than or equal to a second threshold value can be substituted for the second term represented by the verification image. The presentation unit has a function of presenting at least the first term with the highest probability.

In the above embodiment, the model arithmetic unit may have a function of performing an arithmetic operation using a machine learning model.

In the above embodiment, the machine learning model may be learned using the comparison document group.

In the above embodiment, the machine learning model may be a neural network model.

One embodiment of the present invention is a proofreading system including a dividing unit, an appearance frequency obtaining unit, an image generation unit, a model arithmetic unit, and a presentation unit. The dividing unit has a function of dividing a sentence included in a comparison document group into a plurality of first terms, and a function of dividing a sentence included in a designated document into a plurality of second terms. The appearance frequency obtaining unit has a function of obtaining appearance frequencies in the comparison document group of the plurality of second terms. The image generation unit has a function of imaging the first term to obtain a comparison image group. The image generation unit has a function of imaging the second term with the appearance frequency lower than or equal to a first threshold value of the plurality of second terms to obtain a verification image. The model arithmetic unit has a function of inferring a term represented by the verification image. The presentation unit has a function of presenting a result of the inference.

In the above embodiment, the model arithmetic unit may have a function of performing an arithmetic operation using a machine learning model.

In the above embodiment, the machine learning model may be learned using the comparison image group.

In the above embodiment, the machine learning model may be learned by supervised learning using data in which a term as a correct label is linked to the comparison image included in the comparison image group.

In the above embodiment, the machine learning model may include a first classifier and two or more second classifiers, the first classifier may have a function of performing a grouping on the comparison image included in the comparison image group, the second classifier may have a function of inferring a term represented by the comparison image subjected to the grouping, and the inference of the term represented by the comparison image may be performed with the use of the second classifiers differing among the groups.

In the above embodiment, the machine learning model may be a neural network model.

In the above embodiment, the presentation unit may have a function of performing display.

One embodiment of the present invention is a proofreading method using a comparison image group obtained by dividing a sentence included in a comparison document group into a plurality of first terms and imaging the first terms, in which a sentence included in a designated document is divided into a plurality of second terms, the appearance frequencies in the comparison document group of the plurality of second terms are obtained, the second term with the appearance frequency lower than or equal to a threshold value of the plurality of second terms is imaged to obtain a verification image, similarity degrees between the verification image and comparison images included in the comparison image group are obtained, the first term represented by the comparison image with the highest similarity degree of the comparison images is presented.

One embodiment of the present invention is a proofreading method using a comparison image group obtained by dividing a sentence included in a comparison document group into a plurality of first terms and imaging the first terms, in which a sentence included in a designated document is divided into a plurality of second terms, the appearance frequencies in the comparison document group of the plurality of second terms are obtained, the second term with the appearance frequency lower than or equal to a threshold value of the plurality of second terms is imaged to obtain a verification image, similarity degrees between the verification image and comparison images included in the comparison image group are obtained, a probability that the first term represented by the comparison image with the similarity degree greater than or equal to a second threshold value can be substituted for the second term represented by the verification image is obtained, at least the first term with the highest probability is presented.

In the above embodiment, the probability may be obtained using a machine learning model.

In the above embodiment, the machine learning model may be learned using the comparison document group.

In the above embodiment, the machine learning model may be a neural network model.

One embodiment of the present invention is a proofreading method using a comparison image group obtained by dividing a sentence included in a comparison document group into a plurality of first terms and converting the first terms into images, in which a sentence included in a designated document is divided into a plurality of second terms, the appearance frequency in the comparison document group of the plurality of second terms are obtained, the second term with the appearance frequency lower than or equal to a threshold value of the plurality of second terms is imaged to obtain a verification image, a term presented by the verification image is inferred, and a result of the inference is presented.

In the above embodiment, the inference may be made using a machine learning model.

In the above embodiment, the machine learning model may be learned using the comparison image group.

In the above embodiment, the machine learning model may be learned by supervised learning using data in which a term as a correct label is linked to the comparison image included in the comparison image group.

In the above embodiment, the machine learning model may include a first classifier and two or more second classifiers, the first classifier may have a function of performing a grouping on the comparison image included in the comparison image group, the second classifier may have a function of inferring a term represented by the comparison image subjected to the grouping, and the inference may be performed with the use of the second classifiers differing among the groups.

In the above embodiment, the machine learning model may be a neural network model.

In the above embodiment, the presentation may be performed by display

### Effect of the Invention

According to one embodiment of the present invention, a proofreading system or a proofreading method that allows the user to easily judge whether or not there is an error in writing or the like can be provided. According to one embodiment of the present invention, a highly convenient proofreading system or a highly convenient proofreading method can be provided. According to one embodiment of the present invention, a proofreading system or a proofreading method that can detect an error in writing or the like with high accuracy can be provided. According to one embodiment of the present invention, a novel proofreading system or a novel proofreading method can be provided.

Note that the description of these effects does not preclude the existence of other effects. One embodiment of the present invention does not need to have all of these effects. Other effects can be derived from the description of the specification, the drawings, and the claims.

### BRIEF DESCRIPTION OF THE DRAWINGS

FIG. 1 is a diagram showing a structure example of a proofreading system.

FIG. 2 is a diagram showing an example of a proofreading method.

FIG. 3A to FIG. 3C are diagrams showing an example of a proofreading method.

FIG. 4 is a diagram showing an example of a proofreading method.

FIG. 5A to FIG. 5E are diagrams showing an example of a proofreading method.

FIG. 6 is a diagram showing a structure example of a proofreading system.

FIG. 7 is a diagram showing an example of a proofreading method.

FIG. 8 is a diagram showing a structure example of a proofreading system.

FIG. 9 is a diagram showing an example of a proofreading method.

FIG. 10A and FIG. 10B are diagrams showing an example of a proofreading method.

FIG. 11 is a diagram showing an example of a proofreading method.

FIG. 12 is a diagram showing an example of a proofreading method.

FIG. 13 is a diagram showing an example of a proofreading system.

### MODE FOR CARRYING OUT THE INVENTION

Embodiment is described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiment. Note that in structures of the invention described below, the same portions or portions having similar functions are denoted by the same reference numerals in different drawings, and the description thereof is not repeated.

In addition, ordinal numbers such as “first”, “second”, and the like in this specification and the like are used to avoid confusion among components. Thus, the ordinal numbers do not limit the number of components. In addition, the ordinal numbers do not limit the order of components. For example, a “first” component in this specification can be referred to as a “second” component in the scope of claims. Moreover, in this specification, for example, a “first” component in one embodiment can be omitted in the scope of claims.

### Embodiment

In this embodiment, a proofreading system and a proofreading method of one embodiment of the present invention will be described.

In the proofreading system of one embodiment of the present invention, it is possible to distinguish characters that are similar in looking but have different character codes, e.g., “T” (an alphabet) and “T” (a Greek character). For example, when a term “FET” (F and E are alphabets and T is a Greek character) is included in a document, it can be presented to a user of the proofreading system that “FET” (F and E are alphabets and T is a Greek character) can be an error in writing of “FET” (F, E, and T are all alphabets). Thus, the proofreading system of one embodiment of the present invention enables the user to easily find an error in writing or the like that is difficult to find by a visual check.

Specifically, a comparison document group is registered in a database in advance. In addition, sentences included in the comparison document group are divided into terms and the terms are imaged. Such images are referred to as comparison images. The comparison images are also registered in the database.

In this state, a designated document that is a document to be proofread is input to the proofreading system of one embodiment of the present invention. Of the terms included in the designated document, a term having a low appearance frequency in the comparison document group is regarded as a term that can be an error in writing. Such a term is imaged to obtain a verification image. Similarity degrees between the verification image and the comparison images are obtained. The proofreading system of one embodiment of the present invention can present that the term represented by the verification image can be an error in writing of a term represented by the comparison image having a high similarity degree.

### <Proofreading System_1>

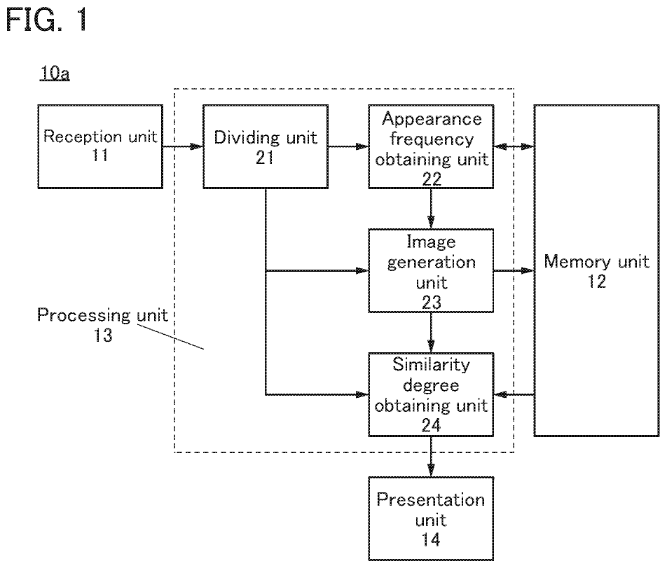

FIG. 1 is a block diagram illustrating a structure example of a proofreading system 10a. The proofreading system 10a includes a reception unit 11, a memory unit 12, a processing unit 13, and a presentation unit 14. The processing unit 13 includes a dividing unit 21, an appearance frequency obtaining unit 22, an image generation unit 23, and a similarity degree obtaining unit 24.

In FIG. 1, exchange of data or the like between the components of the proofreading system 10a is shown by arrows. Note that the exchange of data or the like shown in FIG. 1 is an example, and data or the like can be sometimes exchanged between components that are not connected by an arrow, for example. Furthermore, data or the like is not exchanged between components that are connected by an arrow in some cases. The same applies to block diagrams other than FIG. 1.

The proofreading system 10a may be provided in an information processing device such as a personal computer (PC) used by a user. Alternatively, the memory unit 12 and the processing unit 13 of the proofreading system 10a may be provided in a server to be accessed by a client PC via a network and used.

In this specification and the like, a user of a device or an apparatus provided with a system such as the proofreading system may be simply referred to as a “user of the system”. For example, a user of an information processor provided with the proofreading system may be referred to as a user of the proofreading system.

### [Reception Unit 11]

The reception unit 11 has a function of receiving a document. Specifically, the reception unit 11 has a function of receiving data representing a document. The document supplied to the reception unit 11 can be supplied to the processing unit 13.

In this specification and the like, documents refer to descriptions of events made by natural language unless otherwise specified. The documents are converted into an electronic form to be machine readable. Examples of the documents include patent applications, applications for utility model registration, applications for industrial design registration, applications for trademark registration, legal precedents, contracts, terms and conditions, product manuals, novels, publications, white papers, and technical documents, but are not limited thereto.

### [Memory Unit 12]

The memory unit 12 has a function of storing data supplied to the reception unit 11, data output from the processing unit 13, and the like. Furthermore, the memory unit 12 has a function of storing a program that the processing unit 13 is to execute.

The memory unit 12 includes at least one of a volatile memory and a nonvolatile memory. As the volatile memory, a DRAM (Dynamic Random Access Memory), an SRAM (Static Random Access Memory), and the like can be given. As the nonvolatile memory, an ReRAM (Resistive Random Access Memory, also referred to as a resistance-change memory), a PRAM (Phase-change Random Access Memory), an FeRAM (Ferroelectric Random Access Memory), an MRAM (Magnetoresistive Random Access Memory, also referred to as a magnetoresistive memory), a flash memory, and the like can be given. The memory unit 12 may include a recording media drive. As the recording media drive, a hard disk drive (HDD), a solid state drive (SSD), or the like can be given.

The memory unit 12 may include a database. An application database can be given as an example of the database. Examples of the application include applications relating to intellectual properties, such as patent applications, applications for utility model registration, applications for industrial design registration, and applications for trademark registration. There is no limitation on each status of the applications, i.e., whether or not it is published, whether or not it is pending in the Patent Office, and whether or not it is registered. For example, the application database can contain at least one of applications before examination, applications under examination, and registered applications, or may contain all of them.

For example, the application database preferably contains one or both of specifications and scopes of claims for a plurality of patent applications or applications for utility model registration. The specifications and scopes of claims are stored in text data, for example.

The application database may contain at least one of an application management number for identifying the application (including a number for internal use), an application family management number for identifying the application family, an application number, a publication number, a registration number, a drawing, an abstract, an application date, a priority date, a publication date, a status, a classification (e.g., patent classification or utility model classification), category, a keyword, and the like. These pieces of information may each be used to identify a document when the reception unit 11 receives the document. Alternatively, these pieces of information may each be output together with a processing result of the processing unit 13.

Furthermore, various documents such as a book, a journal, a newspaper, and a paper can be managed with the database. The database contains at least text data of documents. The database may contain at least one of an identification number of each document, the title, the date of issue or the like, the author name, the publisher name, and the like. These pieces of information may each be used to identify a document when a document is received. Alternatively, these pieces of information may each be output together with a processing result of the processing unit 13.

The proofreading system 10a may have a function of extracting data of a document or the like from a database existing outside the system. The proofreading system 10a may have a function of extracting data from both the database of the memory unit 12 and the database existing outside the proofreading system 10a.

One or both of a storage and a file server may be used instead of the database. For example, in the case where the proofreading system 10a uses a file contained in a file server, the path of the file kept in the file server is preferably stored in the memory unit 12.

### [Processing Unit 13]

The processing unit 13 has a function of performing processing such as an arithmetic operation using data supplied from the reception unit 11, data stored in the memory unit 12, and the like. The processing unit 13 can supply the processing result to the memory unit 12 or the presentation unit 14.

The processing unit 13 can include, for example, a central processing unit (CPU). The processing unit 13 may include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The processing unit 13 can interpret and execute instructions from programs with the use of a processor to process various kinds of data and control programs. The programs to be executed by the processor are stored in at least one of a memory region of the processor and the memory unit 12.

The processing unit 13 may include a main memory. The main memory includes at least one of a volatile memory such as a RAM (Random Access Memory) and a nonvolatile memory such as a ROM (Read Only Memory).

For example, a DRAM, an SRAM, and the like are used as the RAM, a virtual memory space is assigned in the RAM and utilized as a working space of the processing unit 13. An operating system, an application program, a program module, program data, a look-up table, and the like that are stored in the memory unit 12 are loaded into the RAM for execution. The data, program, and program module which are loaded into the RAM are each directly accessed and operated by the processing unit 13.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory) which can erase stored data by ultraviolet irradiation, an EEPROM (Electrically Erasable Programmable Read Only Memory), and a flash memory.

The components included in the processing unit 13 are described below.

### <<Dividing Unit 21>>

The dividing unit 21 has a function of dividing sentences included in a document into words. For example, English sentences can be divided into words on the basis of spaces. For another example, Japanese sentences can be divided into words by processing of word divider. The words obtained by the dividing unit 21 can be supplied to the appearance frequency obtaining unit 22, the image generation unit 23, and the similarity degree obtaining unit 24. Here, the dividing unit 21 preferably performs cleaning processing on the sentences when dividing the sentences into words. The cleaning processing removes noise contained in the sentences. For example, in the case of English sentences, the cleaning processing can be removal of semicolons, replacement of colons with commas, and the like.

Furthermore, the dividing unit 21 has a function of performing morphological analysis on the divided words, for example. This enables determination of parts of speech of the words.

Note that the dividing unit 21 need not necessarily divide sentences included in a document into individual words. For example, the dividing unit 21 may divide sentences so that some compound terms are included. In other words, one of the divided terms may include two or more words.

### <<Appearance Frequency Obtaining Unit 22>>

The appearance frequency obtaining unit 22 has a function of obtaining the appearance frequencies of terms obtained when the dividing unit 21 divides sentences, in a document group registered in the database, for example. Specifically, the appearance frequency obtaining unit 22 can obtain the frequency at which a term having the same character code as a term obtained when the dividing unit 21 divides sentences appears in the document group registered in the database, for example. Here, the document group refers to a group of one or more documents. The document group includes, for example, all or some of the documents registered in the database. For example, in the case where patent applications or technical documents such as papers are registered in the database, the document group can be a group of documents in a specific technical field of the documents registered in the database.

The appearance frequency obtaining unit 22 can obtain the appearance frequency of a term as a TF (Term Frequency) value, for example. For example, the appearance frequency obtained by the appearance frequency obtaining unit 22 can be supplied to the memory unit 12 to be registered in the database, and can be supplied to the image generation unit 23.

### <<Image Generation Unit 23>>

The image generation unit 23 has a function of generating image data obtained by imaging terms. The images can be binary data in which text representing terms is shown in white and the background is shown in black, for example. Furthermore, the images may be binary data in which text representing terms is shown in black and the background is shown in white, for example. Furthermore, the images may be multilevel data. For example, text representing terms may be shown in gray and the background may be shown in black or white. Furthermore, text representing terms may be shown in white or black and the background may be shown in gray. Furthermore, the images may be color images.

Specifically, the image generation unit 23 can image the terms obtained by the dividing unit 21. Here, the image generation unit 23 need not necessarily image all the terms obtained by the dividing unit 21. For example, the image generation unit 23 can image terms that are obtained by the dividing unit 21 and whose appearance frequencies obtained by the appearance frequency obtaining unit 22 are lower than or equal to a threshold value.

The images obtained by the image generation unit 23 can be supplied to the memory unit 12 to be registered in the database and can be supplied to the similarity degree obtaining unit 24, for example.

### <<Similarity Degree Obtaining Unit 24>>

The similarity degree obtaining unit 24 has a function of comparing the images obtained by the image generation unit 23 to obtain similarity degrees. The similarity degrees can be obtained by calculation with, for example, region-based matching or feature-based matching. Furthermore, the similarity degree obtaining unit 24 has a function of selecting a term to be supplied to the presentation unit 14 on the basis of the similarity degrees. Here, since the dividing unit 21 performs the above-described cleaning processing, the similarity degrees can be calculated with high accuracy.

The term “calculation” in this specification and the like means, for example, a mathematical operation. The term “obtaining” includes a meaning represented by the term “calculation” but need not necessarily be accompanied with a mathematical operation. For example, reading data from the data base by A can be said as obtaining of data by A.

### [Presentation Unit 14]

The presentation unit 14 has a function of presenting information to the user of the proofreading system 10a on the basis of the processing result of the processing unit 13. The information can be the term output by the similarity degree obtaining unit 24, for example. The presentation unit 14 can present the information to the user of the proofreading system 10a, for example, by displaying the information. That is, the presentation unit 14 can be a display, for example. Furthermore, the presentation unit 14 may have a function of a speaker.

Proofreading for an error in writing or the like can be performed by the proofreading system 10a. For example, a comparison document group is registered in the database included in the memory unit 12 in advance. In addition, sentences included in the comparison document group are divided into terms by the dividing unit 21, and the image generation unit 23 images the terms. Such images are referred to as comparison images. The comparison images are also registered in the database in advance.

In this state, a designated document to be proofread is supplied to the reception unit 11. Of the terms included in the designated document, a term with a low appearance frequency in the comparison document group is regarded as a term that can be an error in writing. The image generation unit 23 images such a term to obtain a verification image. Similarity degrees between the verification image and the comparison images are obtained by the similarity degree obtaining unit 24. The term represented by the verification image and a term represented by the comparison image having a high similarity degree are supplied to the presentation unit 14. The presentation unit 14 can present that the term represented by the verification image can be an error in writing of the term represented by the comparison image having a high similarity degree

In the above manner, the proofreading system 10a can distinguish characters that are similar in looking but have different character codes, e.g., “T” (an alphabet) and “T (a Greek character). For example, when a term “FET” (F and E are alphabets and T is a Greek character) is included in a designated document, it can be presented to the user of the proofreading system 10a that “FET” (F and E are alphabets and T is a Greek character) can be an error in writing of “FET” (F, E, and T are all alphabets). Thus, the proofreading system 10a enables the user to easily find an error in writing or the like that is difficult to find by a visual check. Thus, according to one embodiment of the present invention, a proofreading system or a proofreading method that allows the user to easily judge whether or not there is an error in wiring or the like can be provided. According to one embodiment of the present invention, a highly convenient proofreading system or a highly convenient proofreading method can be provided.

The proofreading system 10a can be used at the time of correcting characters read by optical character recognition (OCR). For example, suppose that a document in which “FET” (F, E, and T are all alphabets) is written is read by OCR but “FET” (F and E are alphabets and T is a Greek character) is recognized. In such a case, the document read by OCR is set as a designated document, whereby the proofreading system 10a can correct “FET” (F and E are alphabets and T is a Greek character) to “FET” (F, E, and T are all alphabets).

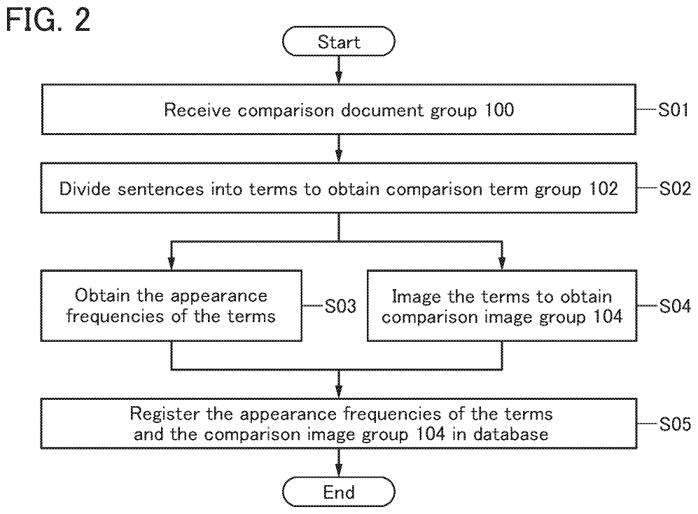

An example of a proofreading method using the proofreading system 10a will be described below with reference to FIG. 2 to FIG. 5.

### <Proofreading Method_1>

First, data necessary for the proofreading system 10a to have a function of performing proofreading is obtained and registered in a database, for example. As described above, the database can be included in the memory unit 12. Alternatively, the database can be a database existing outside the proofreading system 10a.

FIG. 2 is a flowchart showing an example of a method for obtaining data necessary for the proofreading system 10a to have a function of performing proofreading, which includes processing from Step S01 to Step S05.

### [Step S01]

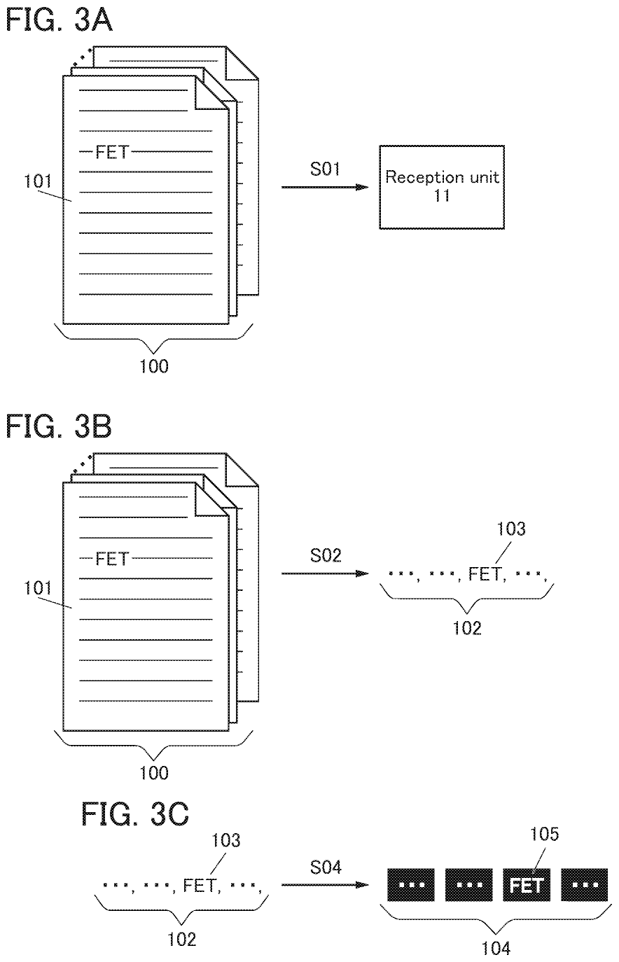

In Step S01, the reception unit 11 receives a comparison document group 100. FIG. 3A is a schematic view illustrating an example of the processing in Step S01. As illustrated in FIG. 3A, the comparison document group 100 is a group of one or more comparison documents 101.

For example, all or some of the documents registered in the database are included in the comparison document group 100 as the comparison documents 101. Here, it is preferable that the comparison document group 100 include, as the comparison documents 101, a large number of documents in the same field as that of the designated document to be proofread, in which case the proofreading system 10a can detect an error in writing or the like with high accuracy. For example, in the case where a patent application or a technical document such as a paper is assumed as the designated document, it is preferable that the comparison documents 101 be also patent applications or technical documents such as papers. In the case where a technical document in the field of electrics is assumed as the designated document, it is preferable that the comparison documents 101 be also technical documents in the field of electrics. In the case where a technical document in the field of semiconductors is assumed as the designated document, it is preferable that the comparison documents 101 be also technical documents in the field of semiconductors.

### [Step S02]

In Step S02, the dividing unit 21 divides sentences contained in the comparison documents 101 into terms to obtain a comparison term group 102. FIG. 3B is a schematic view illustrating an example of the processing in Step S02. As illustrated in FIG. 3B, the comparison term group 102 can be a group of terms 103. FIG. 3B shows an example where a term “FET” is contained in the comparison document 101. In this case, “FET” is also included in the terms 103 included in the comparison term group 102. Here, in the case where a term appears a plurality of times in the comparison document group 100, a plurality of terms 103 identical with the term are included in the comparison term group 102. For example, in the case where a term “FET” appears 100 times in the comparison document group 100, 100 terms 103 of “FET” are included in the comparison term group 102.

As described above, for example, English sentences can be divided into terms on the basis of spaces. In addition, Japanese sentences can be divided into terms, for example, by processing of word divider. For example, morphological analysis may be performed at the time of the division into terms.

Here, the font of text representing the terms 103 included in the comparison term group 102 is preferably uniform. In addition, a plurality of terms that are the identical terms with different text fonts may be prepared as the terms 103 included in the comparison term group 102.

### [Step S03]

In Step S03, the appearance frequency obtaining unit 22 calculates and obtains the appearance frequencies in the comparison document group 100 of the terms 103. As described above, the appearance frequency can be calculated as a TF value, for example. Here, the appearance frequency need not necessarily be obtained for all the terms 103.

For example, in the case where morphological analysis is performed, the appearance frequency may be obtained for only the terms 103 of a specific part of speech. In the case of English sentences, for example, the appearance frequencies of nouns may be obtained and the appearance frequencies of articles need not necessarily be obtained. In the case of Japanese sentences, for example, the appearance frequencies of nouns may be obtained and the appearance frequencies of postpositional particles need not necessarily be obtained.

### [Step S04]

In Step S04, the image generation unit 23 images the terms 103 included in the comparison term group 102 to obtain a comparison image group 104. FIG. 3C is a schematic view illustrating an example of the processing in Step S04. As illustrated in FIG. 3C, the comparison image group 104 can be a group of comparison images 105 obtained by imaging the terms 103. FIG. 3C shows an example where the comparison images 105 are binary data in which text representing the terms 103 is shown in white and the background is shown in black.

In Step S04, for example, the terms 103 whose appearance frequencies in the comparison document group 100 are obtained in Step S03 can be converted into the comparison images 105. Here, as for duplicate terms 103, one of them can be imaged. For example, even in the case where 100 terms 103 of “FET” are included in the comparison term group 102, only one term 103 of “FET” can be imaged.

Note that Step S03 and Step S04 can be performed concurrently. In other words, obtaining of the appearance frequencies by the appearance frequency obtaining unit 22 and the imaging of the terms 103 by the image generation unit 23 can be performed concurrently. Furthermore, Step S04 may be performed after Step S03, and Step S03 may be performed after Step S04.

### [Step S05]

In Step S05, the appearance frequencies of the terms 103 obtained by the appearance frequency obtaining unit 22 in Step S03 and the comparison image group 104 obtained by the image generation unit 23 in Step S04 are registered in the database, for example. As described above, the database can be the database included in the memory unit 12, for example. Furthermore, the appearance frequencies and the comparison image group 104 may be registered in the database existing outside the proofreading system 10a. Note that, for example, in the case where the proofreading system 10a does not execute Step S03 and Step S04 concurrently but executes Step S04 after Step S03, the appearance frequency obtaining unit 22 can obtain the appearance frequencies of the terms 103 by executing Step S03 and register them in the database, and then, the image generation unit 23 can obtain the comparison image group 104 by executing Step S04 and register it in the database.

In the above manner, the proofreading system 10a can have a function of performing proofreading.

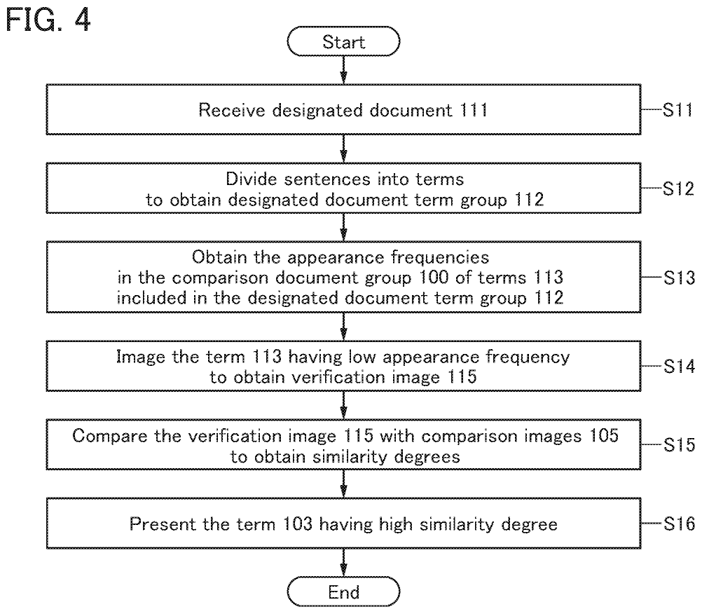

FIG. 4 is a flowchart showing an example of the proofreading method by the proofreading system 10a, which includes processing from Step S11 to Step S16.

### [Step S11]

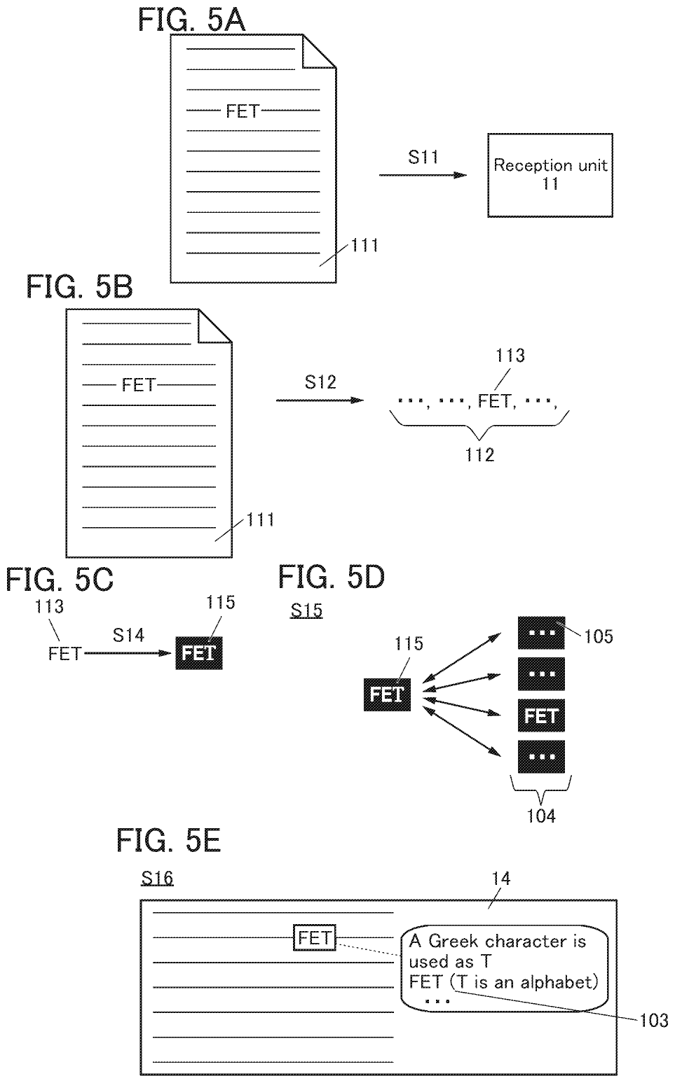

In Step S11, the reception unit 11 receives a designated document 111 that is to be proofread. FIG. 5A is a schematic view illustrating an example of the processing in Step S11. In FIG. 5A, the designated document 111 is one document. Note that the reception unit 11 may receive a plurality of documents as the designated documents 111.

The user of the proofreading system 10a can input the designated document 111 directly to the reception unit 11. Furthermore, the designated document 111 can be, for example, a document registered in the database. For example, in the case where a document registered in the database is used as the designated document 111, the user of the proofreading system 10a can specify the designated document 111 by inputting information that specifies the document (searching the database, for example). As the information that specifies the document, a document identification number, a title, and the like are given.

Furthermore, in the case where proofreading is performed on part of the document (e.g., a specific chapter), the user of the proofreading system 10a may use the part of the document as the designated document 111.

### [Step S12]

In Step S12, the dividing unit 21 divides sentences contained in the designated document 111 into terms to obtain a designated document term group 112. FIG. 5B is a schematic view illustrating an example of the processing in Step S12. As illustrated in FIG. 5B, the designated document term group 112 can be a group of terms 113. FIG. 5B shows an example where one term “FET” (F and E are alphabets and T is a Greek character) is contained in the designated document 111. In this case, “FET” (F and E are alphabets and T is a Greek character) is also included in the terms 113 included in the designated document term group 112.

As described above, for example, English sentences can be divided into the terms 113 on the basis of spaces. In addition, Japanese sentences can be divided into the terms 113, for example, by processing of word divider. For example, morphological analysis may be performed at the time of the division into the terms 113 to determine parts of speech of the terms 113.

Here, for example, in the case where the designated document 111 contains an error in writing or the like at the time when the dividing unit 21 performs morphological analysis, determination of a part of speech cannot be performed on a term containing the error in writing or the like in some cases. For example, “FET” (F and E are alphabets and T is a Greek character) cannot be determined as a noun in some cases. That is, when sentences contained in the designated document 111 are divided into terms, morphological analysis is preferably performed, in which case a term that can be an error in writing or the like can be detected in Step S12.

The font of text representing the terms 113 included in the designated document term group 112 is preferably the same as the font of the text representing the terms 103 included in the comparison term group 102. Therefore, when the font of the text representing the terms 113 is different from the font of the text representing the terms 103, it is preferable that the dividing unit 21 convert the font of the text representing the terms 113.

### [Step S13]

In Step S13, the appearance frequency obtaining unit 22 obtains the appearance frequencies in the comparison document group 100 of the terms 113 included in the designated document term group 112. The appearance frequencies can be obtained by reading from the database and reading from the memory unit 12, for example. For example, the appearance frequency in the comparison document group 100 of the term 103 having the same character code as the character code representing the term 113 can be the appearance frequency in the comparison document group 100 of the term 113. In this case, the term 113 whose appearance frequency cannot be obtained can be regarded as a term that does not appear in the comparison document group 100. Thus, the appearance frequency in the comparison document group 100 of the term 113 whose appearance frequency cannot be obtained can be 0. Note that in Step S13, the appearance frequency obtaining unit 22 may calculate the appearance frequencies in the comparison document group 100 of the terms 113 included in the designated document term group 112. In this case, the appearance frequencies in the comparison document group 100 of the terms 103 need not necessarily be registered in the database, for example. Accordingly, for example, Step S03 shown in FIG. 2 can be omitted.

Here, the appearance frequency need not necessarily be obtained for all the terms 113. For example, in the case where morphological analysis is performed in Step S12, it is highly probable that the appearance frequency in the comparison document group 100 of the term 113 whose part of speech cannot be determined is low. Thus, the appearance frequency obtaining unit 22 need not necessarily obtain the appearance frequency of the term 113 whose part of speech cannot be determined.

The term 113 having a low appearance frequency in the comparison document group 100 can be regarded as being possibly an error in writing or the like. Here, when the designated document 111 is of the same field as that of many of the documents included in the comparison document group 100, the appearance frequency of the term 113 that is not probably an error in writing or the like can be inhibited from becoming low. Accordingly, the detection accuracy of an error in writing or the like can be improved.

### [Step S14]

In Step S14, the image generation unit 23 images the term 113 that can be an error in writing or the like, i.e., the term 113 having a low appearance frequency in the comparison document group 100, to obtain a verification image 115. For example, the term 113 whose appearance frequency is lower than a threshold value is imaged. In the case where, for example, morphological analysis is performed in Step S13, the term 113 whose part of speech cannot be determined is imaged.

At the time of selecting the term 113 to be imaged, dispersion of the appearance frequencies may be taken into consideration. With the dispersion taken into consideration, for example, the term 113 whose appearance frequency in the comparison document group 100 is significantly lower than those of the other terms 113 can be determined as being possibly an error in writing or the like. Accordingly, it is possible to inhibit the proofreading system 10a from determining the term 113 that is not probably an error in writing or the like to be highly probably an error in writing or the like. Therefore, the proofreading system 10a can detect the term 113 that can be an error in writing or the like with high accuracy.

FIG. 5C is a schematic view illustrating an example of the processing in Step S14. FIG. 5C shows an example where the image generation unit 23 images “FET” (F and E are alphabets and T is a Greek character) of the terms 113 to obtain the verification image 115. As shown in FIG. 5C, the verification image 115 can be binary data in which text representing the term 113 is shown in white and the background is shown in black, for example.

### [Step S15]

In Step S15, the similarity degree obtaining unit 24 compares the verification image 115 with the comparison images 105 included in the comparison image group 104. Thus, the similarity degree obtaining unit 24 obtains the similarity degrees between the verification image 115 and the comparison images 105. FIG. 5D is a schematic view illustrating an example of the processing in Step S15. The verification image 115 represents “FET” (F and E are alphabets and T is a Greek character) and has a high similarity degree with the comparison image 105 representing “FET” (F, E, and T are all alphabets). As described above, the similarity degree can be obtained by calculation with, for example, region-based matching or feature-based matching.

### [Step S16]

In Step S16, the presentation unit 14 presents the term 103 represented by the comparison image 105 whose similarity degree with the verification image 115 obtained in Step S15 is high. It is preferable that the presentation unit 14 present at least the term 103 represented by the comparison image 105 having the highest similarity degree with the verification image 115. For example, the presentation unit 14 can present a predetermined number of terms 103 counted from the term 103 represented by the comparison image 105 having the highest similarity degree with the verification image 115. Alternatively, the presentation unit 14 can present the term 103 represented by the comparison image 105 whose similarity degree is different from the highest similarity degree by a threshold value or less. Alternatively, the presentation unit 14 can present the term 103 represented by the comparison image 105 whose similarity degree with the verification image 115 is greater than or equal to a threshold value.

FIG. 5E is a schematic view illustrating an example of the processing in Step S16. As illustrated in FIG. 5E, the presentation unit 14 can be, for example, a display and can present that the term represented by the verification image 115 can be an error in writing of the term 103 represented by the comparison image 105 having a high similarity degree.

Here, the processing unit 13 may have a function of comparing the term 113 represented by the verification image 115 with the term 103 presented by the presentation unit 14. The comparison can be performed by detection of a difference between the character code representing the term 113 and the character code representing the term 103 presented by the presentation unit 14, for example. This makes it possible for the presentation unit 14 to present the difference. FIG. 5E shows an example where it is displayed in the margin of the document that “T” of “FET” included in the document is a Greek character and can be an error in writing of “FET” (T is an alphabet). Note that, for example, the similarity degree obtaining unit 24 included in the processing unit 13 can perform the comparison between the term 113 represented by the verification image 115 and the term 103 presented by the presentation unit 14.

In the above manner, the proofreading system 10a can distinguish characters that are similar in looking but have different character codes. For example, when a term “FET” (F and E are alphabets and T is a Greek character) is included in the designated document 111, it can be presented to the user of the proofreading system 10a that “FET” (F and E are alphabets and T is a Greek character) can be an error in writing of “FET” (F, E, and T are all alphabets). Thus, the proofreading system 10a enables the user to easily find an error in writing or the like that is difficult to find by a visual check. Thus, according to one embodiment of the present invention, a proofreading system or a proofreading method that allows the user to easily judge whether or not there is an error in wiring or the like can be provided. According to one embodiment of the present invention, a highly convenient proofreading system or a highly convenient proofreading method can be provided.

The proofreading system 10a can be used at the time of correcting characters read by optical character recognition (OCR). For example, suppose that a document in which “FET” (F, E, and T are all alphabets) is written is read by OCR and “FET” (F and E are alphabets and T is a Greek character) is recognized. In such a case, the document read by OCR is set as the designated document 111, whereby the proofreading system 10a can correct “FET” (F and E are alphabets and T is a Greek character) to “FET” (F, E, and T are all alphabets).

### <Proofreading System_2>

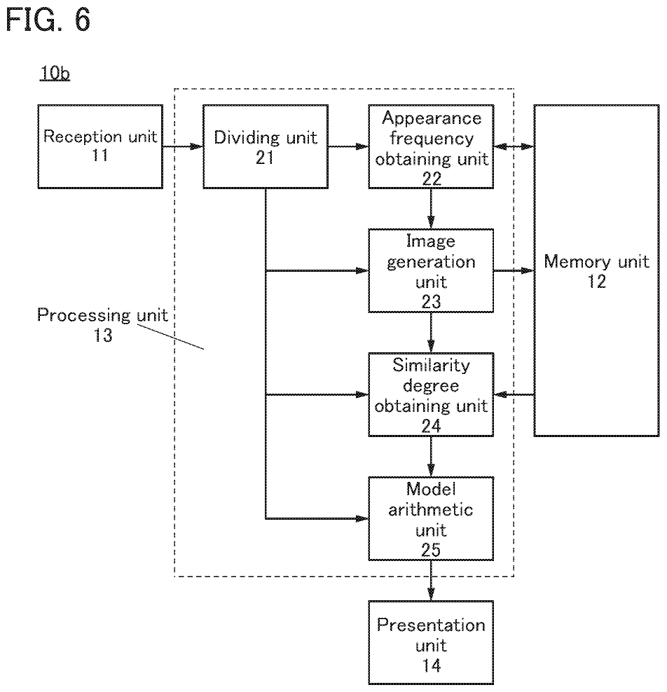

FIG. 6 is a block diagram illustrating a structure example of a proofreading system 10b. The proofreading system 10b is a modification example of the proofreading system 10a and is different from the proofreading system 10a in that the processing unit 13 includes a model arithmetic unit 25. Differences of the proofreading system 10b from the proofreading system 10a will be mainly described below.

For example, data output by the dividing unit 21, data output by the similarity degree obtaining unit 24, and the like are supplied to the model arithmetic unit 25. Data output by the model arithmetic unit 25 and the like are supplied to the presentation unit 14, for example.

The model arithmetic unit 25 has a function of performing an arithmetic operation with a mathematical model. The model arithmetic unit 25 has, for example, a function of performing an arithmetic operation with a machine learning model, e.g., a function of performing an arithmetic operation with a neural network model.

In this specification and the like, a neural network model refers to a general model that is modeled on a biological neural network, determines the connection strength of neurons by learning, and has the capability of solving problems. A neural network model includes an input layer, intermediate layers (hidden layers), and an output layer.

### <Proofreading Method_2>

An example of a proofreading method using the proofreading system 10b will be described below. Data necessary for the proofreading system 10b to have a function of performing proofreading can be obtained by, for example, the same method as that shown in FIG. 2 and FIG. 3A to FIG. 3C.

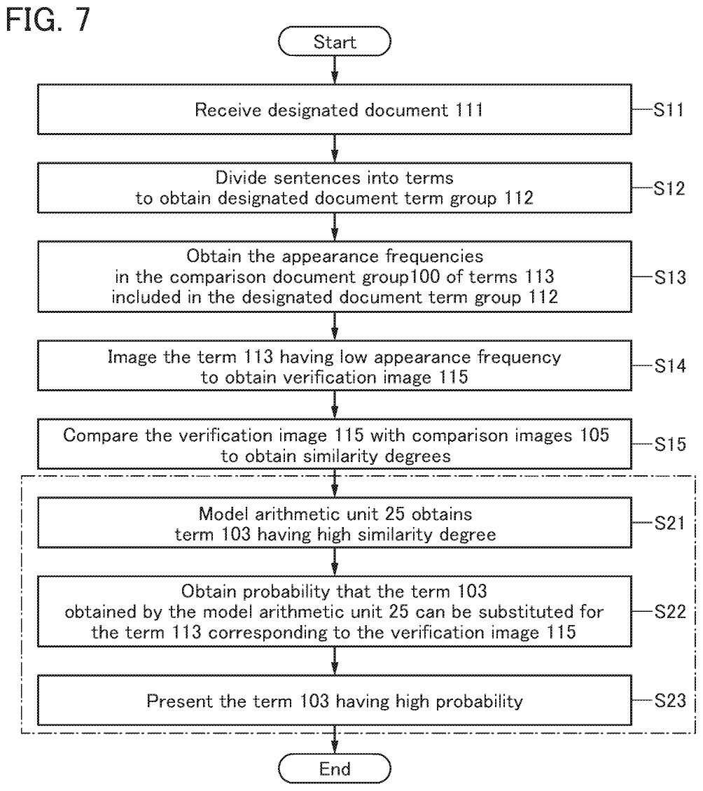

FIG. 7 is a flowchart showing an example of the proofreading method by the proofreading system 10b, which includes processing from Step S11 to Step S15 and Step S21 to Step S23.

The processing from Step S11 to Step S15 can be the same as the processing from Step S11 to Step S15 shown in FIG. 4. In FIG. 7, processing different from the processing shown in FIG. 4 is surrounded by a dashed-dotted line.

### [Step S21]

In Step S21, the similarity degree obtaining unit 24 supplies, to the model arithmetic unit 25, the term 103 represented by the comparison image 105 whose similarity degree with the verification image 115 obtained in Step S15 is high. Thus, the model arithmetic unit 25 can obtain the term 103 represented by the comparison image 105 having the high similarity degree.

It is preferable that the similarity degree obtaining unit 24 supply at least the term 103 represented by the comparison image 105 having the highest similarity degree with the verification image 115, to the model arithmetic unit 25. For example, the similarity degree obtaining unit 24 can supply a predetermined number of terms 103 counted from the term 103 represented by the comparison image 105 having the highest similarity degree with the verification image 115, to the model arithmetic unit 25. Alternatively, the similarity degree obtaining unit 24 can supply the term 103 represented by the comparison image 105 whose similarity degree is different from the highest similarity degree by a threshold value or less, to the model arithmetic unit 25. Alternatively, the similarity degree obtaining unit 24 can supply the term 103 represented by the comparison image 105 whose similarity degree with the verification image 115 is greater than or equal to a threshold value, to the model arithmetic unit 25.

### [Step S22]

In Step S22, a probability that the term 103 obtained by the model arithmetic unit 25 can be substituted for the term 113 corresponding to the verification image 115 is obtained for each term 103. Specifically, a language model is incorporated in the model arithmetic unit 25, and the probability is calculated using the language model. The probability can be calculated on the basis of, for example, sentences included in the designated document 111. For example, the term 103 is substituted for the term 113 in sentences, paragraphs, or the like including the term 113 corresponding to the verification image 115, the sentences, the paragraphs, or the like are supplied to the language model, and then the appearance probability of the substituted term 103 is calculated. This makes it possible to calculate the probability that the term 103 obtained by the model arithmetic unit 25 can be substituted for the term 113 corresponding to the verification image 115.

The above language model can be a rule-based model, for example. Alternatively, the above language model can be a model using a conditional random field (CRF), for example. Alternatively, the above language model can be a machine learning model, specifically, a neural network model, for example. For example, a recurrent neural network (RNN) can be used as the neural network model. As the architecture of the RNN, a long short-term memory (LSTM) can be used, for example.

Here, in the case where the model arithmetic unit 25 calculates the probability with the use of a machine learning model, it is preferable to use a document highly related to the designated document 111, in which case the probability can be calculated with high accuracy. As described above, a large number of documents of the same field as that of the designated document 111 are included in the comparison document group 100, for example. Therefore, the comparison document group 100 is preferably used for learning of the machine learning model.

### [Step S23]

In Step S23, the presentation unit 14 presents the term 103 for which the above-described probability is high. It is preferable that the presentation unit 14 present at least the term 103 for which the probability is the highest. For example, the presentation unit 14 can present a predetermined number of terms 103 counted from the term 103 for which the probability is the highest. Alternatively, the presentation unit 14 can present the term 103 whose probability is different from the highest probability by a threshold value or less. Alternatively, the presentation unit 14 can present the term 103 whose probability is greater than or equal to a threshold value.

In the proofreading system 10b, the term 103 that is similar in looking when imaged but has a significantly different meaning and is not probably a correction candidate for the error in writing or the like in terms of context can be inhibited from being presented to the presentation unit 14. Thus, the proofreading system 10b can be a highly convenient proofreading system.

### <Proofreading System_3>

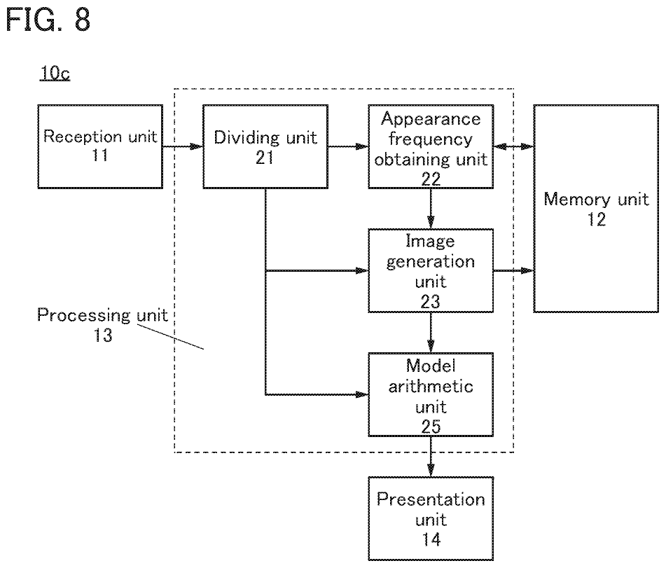

FIG. 8 is a block diagram illustrating a structure example of a proofreading system 10c. The proofreading system 10c is a modification example of the proofreading system 10b and different from the proofreading system 10b in that the processing unit 13 does not include the similarity degree obtaining unit 24. In the proofreading system 10c, for example, data output by the image generation unit 23 is supplied to the model arithmetic unit 25.

### <Proofreading Method_3>

An example of a proofreading method using the proofreading system 10c will be described below. Here, the model arithmetic unit 25 includes an image determination model. The image determination model has a function of inferring a term represented by an image when data obtained by imaging the term is supplied to the model arithmetic unit 25.

The image determination model can be a machine learning model, specifically, a neural network model, for example. For example, a convolutional neural network (CNN) can be used as the neural network model.

Data necessary for the proofreading system 10c to have a function of performing proofreading can be obtained by, for example, the same method as that shown in FIG. 2 and FIG. 3A to FIG. 3C.

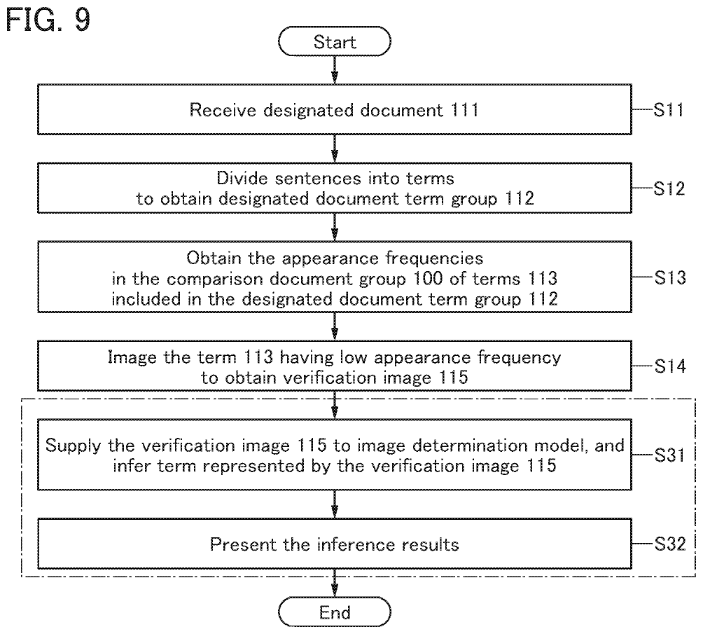

FIG. 9 is a flowchart showing an example of the proofreading method by the proofreading system 10c, which includes processing from Step S11 to Step S14, Step S31, and Step S32.

The processing from Step S11 to Step S14 can be the same as the processing from Step S11 to Step S14 shown in FIG. 4. In FIG. 9, processing different from the processing shown in FIG. 4 is surrounded by a dashed-dotted line.

### [Step S31]

In Step S31, the verification image 115 is supplied to the image determination model incorporated in the model arithmetic unit 25. Thus, the image determination model infers a term represented by the verification image 115. Specifically, the image determination model calculates the probability of the term represented by the verification image 115. For example, in the case where data obtained by imaging the term “FET” (F and E are alphabets and T is a Greek character) is supplied to the image determination model, the image determination model can determines that the term is “FET” (F, E, and T are all alphabets) with high probability.

### [Step S32]

In Step S32, the presentation unit 14 presents the inference results. Specifically, the presentation unit 14 presents a term for which a probability of being the term represented by the verification image 115 is high. It is preferable that the presentation unit 14 present at least a term for which the probability is the highest. For example, the presentation unit 14 can present a predetermined number of terms counted from the term having the highest probability. Alternatively, the presentation unit 14 can present a term whose probability is different from the highest probability by a threshold value or less. Alternatively, the presentation unit 14 can present a term whose probability is greater than or equal to a threshold value.

In the proofreading system 10c, the similarity degree between the verification image 115 and the comparison image 105 is not necessarily calculated with region-based matching, feature-based matching, or the like. Accordingly, the amount of calculation in the processing unit 13 can be reduced. Therefore, the proofreading system 10c can be a proofreading system that is driven at high speed and consumes low power.

### [Image Determination Model]

A structure example of the image determination model and an example of a learning method of the case where a machine learning model is used as the image determination model that can be incorporated in the model arithmetic unit 25 will be described below.

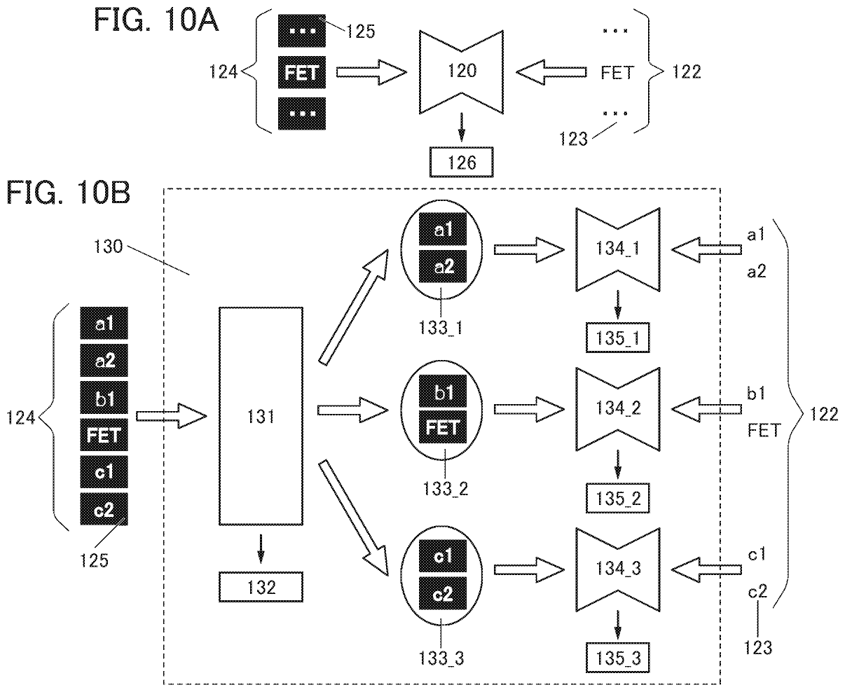

FIG. 10A is a schematic diagram showing an example of a learning method of an image determination model 120. To perform learning of the image determination model 120, first, a learning document is supplied to the reception unit 11. After that, for example, the dividing unit 21 obtains a learning term group 122 in the same manner as that of Step S02 shown in FIG. 2, and the image generation unit 23 obtains a learning image group 124 in the same manner as that of Step S04. The learning term group 122 can be a group of terms 123, and the learning image group 124 can be a group of learning images 125. Learning of the image determination model 120 can be performed by supervised learning using data in which the term 123 is linked to the learning image 125 as a correct label. The learning enables the image determination model 120 to obtain a learning result 126. The learning result 126 can be, for example, a weight coefficient.

Here, it is preferable to use a document highly related to the designated document 111, in which case the term represented by the verification image 115 can be inferred with high accuracy. As described above, a large number of documents of the same field as that of the designated document 111 are included in the comparison document group 100, for example. Therefore, the comparison document group 100 is preferably used as learning documents.

The learning images 125 included in the learning image group 124 are not limited to images themselves obtained by the image generation unit 23. For example, an image obtained by performing translational motion, rotation, scaling, or the like on a term included in the image obtained by the image generation unit 23 may be included in the learning image group 124. This can increase the number of learning images 125. Accordingly, the image determination model 120 can perform learning so as to make an inference with high accuracy. Therefore, the proofreading system of one embodiment of the present invention can detect an error in writing or the like included in the designated document 111 with high accuracy.

In addition, an image including a character that is similar in looking but has a different character code may be included in the learning image group 124 as the learning image 125. Furthermore, an image including an error in writing that is likely to be caused may be included in the learning image group 124 as the learning image 125. For example, when the image generation unit 23 images a term “out-of-plane” (- is a hyphen), the learning image group 124 may include the learning image 125 obtained by imaging a term “out-of-plane” (— is a negative sign) in addition to the learning image 125 obtained by imaging the term “out-of-plane” (- is a hyphen). In this case, for example, the term 123 “out-of-plane” (- is a hyphen) can be linked, as a correct label, to both the learning image 125 obtained by imaging the term “out-of-plane” (- is a hyphen) and the learning image 125 obtained by imaging the term “out-of-plane” (— is a negative sign). For example, in the case where the image generation unit 23 images a term “system”, the learning image group 124 may include the learning image 125 obtained by imaging a term “systm”, which includes an error in writing, in addition to the learning image 125 obtained by imaging the term “system”. In this case, the term 123 “system” can be linked, as a correct label, to both the learning image 125 obtained by imaging the term “system” and the learning image 125 obtained by imaging the term “systm”.

In the above manner, for example, the verification image 115 supplied to the image determination model 120 in Step S31 shown in FIG. 9 can be approximated to the learning image 125. Accordingly, the image determination model 120 can make an inference with high accuracy. Specifically, the image determination model 120 can infer the term represented by the verification image 115 with high accuracy. Thus, the proofreading system of one embodiment of the present invention can detect an error in writing or the like included in the designated document 111 with high accuracy.

FIG. 10B is a schematic diagram showing a structure example of an image determination model 130 and an example of a learning method. The image determination model 130 includes a classifier 131 and a plurality of classifiers 134.

In this specification and the like, when a plurality of components are denoted by the same reference numerals, and in particular need to be distinguished from each other, an identification sign such as “_” is sometimes added to the reference numerals.

When images are supplied to the image determination model 130, first, the classifier 131 classifies the images. The images classified by the classifier 131 can be further classified by the classifiers 134 corresponding to the classification results. Specifically, the classifier 134 can infer a term represented by the image. In other words, after the classifier 131 performs a grouping on the image supplied to the image determination model 130, the classifier 134 corresponding to the group to which the image belongs can infer the term. In the above manner, after the image determination model 130 performs primary classification by the classifier 131, the image determination model 130 can perform secondary classification by the classifiers 134.

FIG. 10B is a schematic diagram showing an example of a learning method of the image determination model 130. FIG. 10B shows an example where learning of the classifier 131 is performed by clustering, which is unsupervised learning. For example, when the learning image group 124 is supplied to the classifier 131, clustering can be performed on the basis of the feature values of the learning images 125 included in the learning image group 124. The clustering can be performed by K-means, for example. Furthermore, the clustering can be performed by a single linkage method, a complete linkage method, a group average method, a Ward's method, a centroid method, a weighted average method, or a median method. The classifier 131 can obtain a learning result 132 by the above learning. The learning result 132 can be, for example, a weight coefficient.

In the example shown in FIG. 10B, six images obtaining by imaging terms “a1”, “a2”, “b1”, “FET”, “c1”, and “c2” are supplied to the classifier 131 as the learning images 125. Furthermore, in the example shown in FIG. 10B, three clusters 133 are generated by clustering. Moreover, in the example shown in FIG. 10B, two learning images 125 obtained by imaging the terms “a1” and “a2” are included in a cluster 133_1, two learning images 125 obtained by imaging the terms “b1” and “FET” are included in a cluster 133_2, and two learning images 125 obtained by imaging the terms “c1” and “c2” are included in a cluster 133_3.

In the example shown in FIG. 10B, the classifier 134 can be provided for each cluster 133. In other words, for example, when three clusters 133 are generated by clustering, three classifiers 134 can be provided. In the example shown in FIG. 10B, the images classified to the cluster 133_1 are supplied to a classifier 134_1, the images classified to the cluster 133_2 are supplied to the classifier 134_2, and the images classified to the cluster 133_3 are supplied to a classifier 134_3.

The classifier 134 has a function of inferring a term represented by an image. In other words, the classifier 134 has the same function as the image determination model 120 shown in FIG. 10A. Learning of the classifier 134 can be performed in the same manner as the learning of the image determination model 120. In other words, the learning of the classifier 134 can be performed by supervised learning using data in which the term 123 as a correct label is linked to the learning image 125 included in each cluster 133. The learning enables the classifier 134 to obtain a learning result 135. Here, the learning results 135 obtained by the classifier 134_1 to the classifier 134_3 are referred to as a learning result 135_1 to a learning result 135_3, respectively. The learning result 135 can be, for example, a weight coefficient.

Note that FIG. 10B shows the example where the classifier 131 performs unsupervised learning and the classifier 134 performs supervised learning, the learning method of the image determination model 130 is not limited thereto. For example, both the classifier 131 and the classifier 134 may perform supervised learning.

The learning of the whole image determination model 130 can be performed in the same manner as the image determination model 120. That is, the data in which the term 123 as a correct label is linked to the learning image 125 is supplied to the image determination model 130, whereby the learning of the image determination model 130 can be performed by supervised learning.

For example, when an image such as the verification image 115 is supplied to the image determination model 130 that is learned by the method shown in FIG. 10B, the image is classified to any of the clusters 133. After that, a term represented by the verification image 115 is inferred by the classifier 134 corresponding to the cluster 133 to which the image is classified.

In the image determination model 130, after an image is classified into a cluster, a term represented by the image is inferred. Thus, the scale of the classifier 134, which is a model for inferring a term represented by an image, can be small. Accordingly, the image determination model 130 is a machine learning model that facilitates learning and makes it possible to make an inference with high accuracy. Specifically, the term represented by the verification image 115 can be inferred with high accuracy. Therefore, the proofreading system of one embodiment of the present invention can detect an error in writing or the like included in the designated document 111 with high accuracy. Although the image determination model 130 performs up to secondary classification in the example shown in FIG. 10B, the image determination model 130 may perform up to tertiary classification or quaternary or more classification. For example, when the image determination model 130 performs up to tertiary classification, the term represented by the image can be inferred by the tertiary classification.

### <Proofreading Method_4>

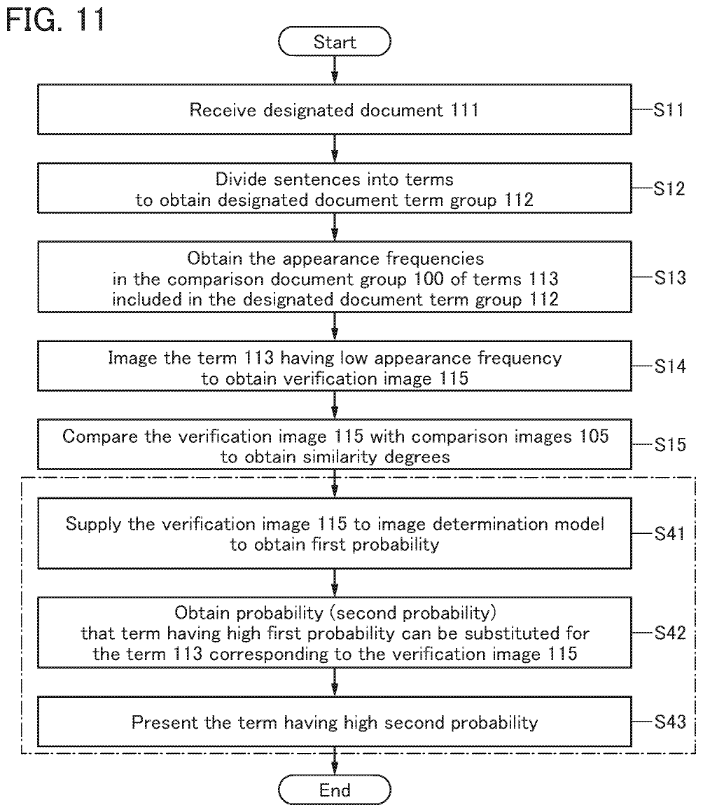

Proofreading method_1 to Proofreading method_3 described above can be combined with each other as appropriate. FIG. 11 is a flowchart showing an example of a proofreading method with a combination of the methods shown in Proofreading method_1 to Proofreading method_3, which includes processing from Step S11 to Step S15 and Step S41 to Step S43. The processing shown in FIG. 11 can be performed by the proofreading system 10b. Here, an image determination model as well as a language model is incorporated in the model arithmetic unit 25.

The processing from Step S11 to Step S15 can be the same as the processing from Step S11 to Step S15 shown in FIG. 4. In FIG. 11, processing different from that shown in FIG. 4 is surrounded by a dashed-dotted line.

### [Step S41]

In Step S41, the verification image 115 is supplied to the image determination model incorporated in the model arithmetic unit 25. Thus, the model arithmetic unit 25 calculates the probability of the term represented by the verification image 115. The probability is referred to as a first probability. The first probability is calculated in consideration of the similarity degrees obtained by the similarity degree obtaining unit 24 in Step S15. For example, a value corresponding to the similarity degree with the verification image 115 of the comparison image 105 obtained by imaging the term for which the probability is calculated is added to a value corresponding to the probability calculated by the image determination model, whereby the first probability is calculated. By Step S41, the model arithmetic unit 25 can obtain the first probability.

### [Step S42]

In Step S42, the model arithmetic unit 25 obtains a probability that a term having a high first probability can be substituted for the term 113 corresponding to the verification image 115. The probability is referred to as a second probability. The second probability can be calculated by the language model incorporated in the model arithmetic unit 25.

Here, it is preferable that the model arithmetic unit 25 calculate at least the second probability of the term having the highest first probability. For example, the model arithmetic unit 25 can calculate the second probabilities of a predetermined number of terms counted from the term having the highest first probability. Alternatively, the model arithmetic unit 25 can calculate the second probability of a term whose first probability is different from the highest first probability by a threshold value or less. Alternatively, the model arithmetic unit 25 can calculate the second probability of a term whose first probability is greater than or equal to a threshold value.

### [Step S43]

In Step S43, the presentation unit 14 presents a term having a high second probability. It is preferable that the presentation unit 14 present at least the term having the highest second probability. For example, the presentation unit 14 can present a predetermined number of terms counted from the term having the highest second probability. Alternatively, the presentation unit 14 can present a term whose second probability is different from the highest probability by a threshold value or less. Alternatively, the presentation unit 14 can present a term whose second probability is greater than or equal to a threshold value.

For example, the proofreading system of one embodiment of the present invention is driven by the method shown in FIG. 11, whereby the convenience of the proofreading system of one embodiment of the present invention can be improved while the detection accuracy for an error in writing or the like included in the designated document 111 is increased.

### <Proofreading Method_5>

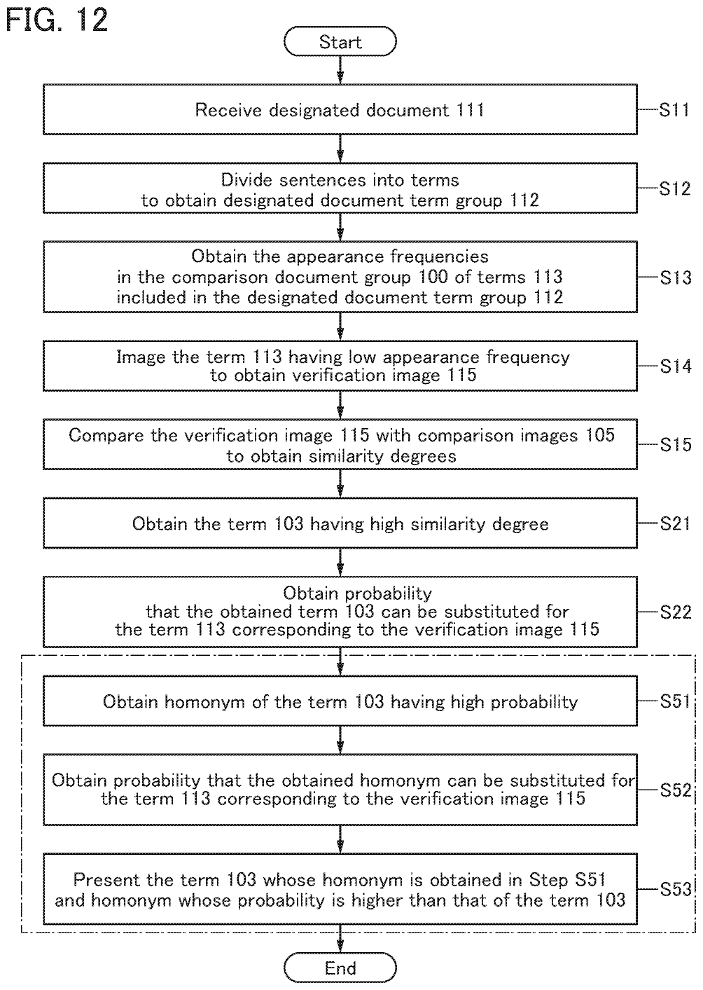

FIG. 12 is a flowchart showing an example of the proofreading method by the proofreading system 10b, which includes processing from Step S11 to Step S15, Step S21, Step S22, and Step S51 to Step S53.

The processing from Step S11 to Step S15 and Step S21 to Step S22 can be the same as the processing shown in FIG. 7. In FIG. 12, processing different from that shown in FIG. 7 is surrounded by a dashed-dotted line.

### [Step S51]

In Step S51, the model arithmetic unit 25 obtains a homonym of the term 103 having a high probability of being substituted for the term 113 corresponding to the verification image 115, of the terms 103 for which the probabilities are obtained. It is preferable that the model arithmetic unit 25 obtain at least a homonym of the term 103 having the highest probability. For example, the model arithmetic unit 25 can obtain homonyms of a predetermined number of terms 103 counted from the term 103 having the highest probability. Alternatively, the model arithmetic unit 25 can obtain a homonym of the term 103 whose probability is different from the highest probability by a threshold value or less. Alternatively, the model arithmetic unit 25 can obtain a homonym of the term 103 whose probability is greater than or equal to a threshold value.

### [Step S52]

In Step S52, the model arithmetic unit 25 obtains a probability that the obtained homonym can be substituted for the term 113 corresponding to the verification image 115. The probability can be calculated by the language model incorporated in the model arithmetic unit 25.

### [Step S53]

In Step S53, the model arithmetic unit 25 presents the term 103 itself whose homonym is obtained and a homonym whose probability of being substituted for the term 113 corresponding to the verification image 115 is higher than that of the term 103, to the presentation unit 14. For example, a homonym whose probability is higher than the probability of the term 103 by a threshold value or more can be presented to the presentation unit 14.

When the proofreading system 10b and the like are driven by the method shown in FIG. 11 and the like, the proofreading system 10b can detect an error in writing for a homonym or the like. For example, in the case where the designated document 111 includes a Japanese sentence, misconversion of a kanji character can be detected. Accordingly, the convenience of the proofreading system 10b can be improved.

### <Proofreading Method_6>

In the methods shown in FIG. 4, FIG. 7, FIG. 9, FIG. 11, and FIG. 12, the dividing unit 21 divides sentences included in the designated document 111 into the terms 113 in Step S12. As described above, for example, English sentences can be divided into the terms 113 on the basis of spaces. In this case, when a term “tran sistor” is included in the designated document 111 as an error in writing of a term “transistor”, “tran” and “sistor” are separated as different terms 113 in some cases. When a term “tran” is not included in the comparison term group 102, the comparison image 105 having a high similarity degree with the verification image 115 obtained by imaging a term “tran” does not exist in some cases. Similarly, when a term “sistor” is not included in the comparison term group 102, the comparison image 105 having a high similarity degree with the verification image 115 obtained by imaging a term “sistor” does not exist in some cases. Thus, for example, even when the term “tran sistor” is included in the designated document 111, “transistor” cannot be presented as a correction candidate in some cases.

In such a case, it is preferable to divide the sentences by a predetermined number of characters by N-gram (also referred to as an N-character index method, an N-gram, or the like) or the like. For example, in the case where sentences included in the designated document 111 are divided by 10 characters, “tran sistor” can be one term 113 assuming that spaces are not included in the number of characters.

Specifically, for example, in Step S12, sentences included in the designated document 111 are divided into the terms 113 on the basis of spaces. Thus, in the case where a term “tran sistor” is included in the designated document 111, “tran” and “sistor” are separated as different terms 113 in Step S12.

In Step S13, the appearance frequency obtaining unit 22 obtains the appearance frequencies in the comparison document group 100 of the terms 113. Here, the appearance frequency of “tran” and the appearance frequency of “sistor” are both low. The appearance frequency of the term 113 immediately before “tran” and the appearance frequency of the term 113 immediately after “sistor” are both high. In this case, N-gram is applied to the series of the terms 113 having low appearance frequencies, which are sandwiched between the terms 113 having high appearance frequencies. Thus, the appearance frequency obtaining unit 22 can obtain the term 113 “tran sistor”.

In Step S14, the image generation unit 23 images not only the term 113 having a low appearance frequency in the comparison document group 100 but also the term 113 obtained by N-gram, thereby obtaining the verification image 115. After that, the processing shown in FIG. 4, FIG. 7, FIG. 9, FIG. 11, or FIG. 12 is performed.

The verification image 115 obtained by imaging the term 113 “tran sistor” has a high similarity degree with the comparison image 105 obtained by imaging the term 103 “transistor”. Thus, the presentation unit 14 can present that “tran sistor” included in the designated document 111 can be an error in writing of “transistor”. Therefore, the convenience of the proofreading system of one embodiment of the present invention can be improved.

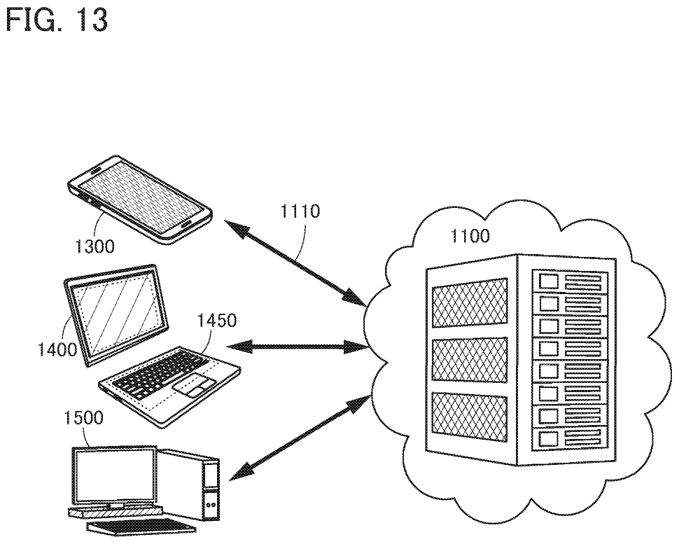

FIG. 13 is a conceptual diagram of the proofreading system of this embodiment.

The proofreading system illustrated in FIG. 13 includes a server 1100 and terminals (also referred to as electronic devices). Communication between the server 1100 and each terminal is conducted via an Internet connection 1110.

The server 1100 is capable of performing an arithmetic operation using data input from the terminal via the Internet connection 1110. The server 1100 is capable of transmitting an arithmetic operation result to the terminal via the Internet connection 1110. Accordingly, the burden of arithmetic operation on the terminal can be reduced.

In FIG. 13, an information terminal 1300, an information terminal 1400, and an information terminal 1500 are shown as the terminals. The information terminal 1300 is an example of a portable information terminal such as a smartphone. The information terminal 1400 is an example of a tablet terminal. When the information terminal 1400 is connected to a housing 1450 with a keyboard, the information terminal 1400 can be used as a notebook information terminal. The information terminal 1500 is an example of a desktop information terminal.

With such a structure, a user can access the server 1100 from the information terminal 1300, the information terminal 1400, the information terminal 1500, and the like. Then, through the communication via the Internet connection 1110, the user can receive a service offered by an administrator of the server 1100. Examples of the service include a service with use of the proofreading method of one embodiment of the present invention. In the service, an artificial intelligence may be utilized in the server 1100.

### REFERENCE NUMERALS

10a: proofreading system, 10b: proofreading system, 10c: proofreading system, 11: reception unit, 12: memory unit, 13: processing unit, 14: presentation unit, 21: dividing unit, 22: appearance frequency obtaining unit, 23: image generation unit, 24: similarity degree obtaining unit, 25: model arithmetic unit, 100: comparison document group, 101: comparison document, 102: comparison term group, 103: term, 104: comparison image group, 105: comparison image, 111: designated document, 112: designated document term group, 113: term, 115: verification image, 120: image determination model, 122: learning term group, 123: term, 124: learning image group, 125: learning image, 126: learning result, 130: image determination model, 131: classifier, 132: learning result, 133: cluster, 134: classifier, 135: learning result, 1100: server, 1110: Internet connection, 1300: information terminal, 1400: information terminal, 1450: housing, 1500: information terminal

1. A proofreading system comprising:
a dividing unit, an appearance frequency obtaining unit, an image generation unit, a similarity degree obtaining unit, and a presentation unit,
wherein the dividing unit is configured to divide a sentence included in a comparison document into a plurality of first terms, and divide a sentence included in a designated document into a plurality of second terms,
wherein the appearance frequency obtaining unit is configured to obtain an appearance frequency of each of the plurality of second terms in the comparison document,
wherein the image generation unit is configured to image each of the plurality of first terms to obtain a plurality of comparison images,
wherein the image generation unit is configured to image the second term with the appearance frequency lower than or equal to a threshold value to obtain a verification image,
wherein the similarity degree obtaining unit is configured to obtain similarity degrees between the verification image and each of the plurality of comparison images, and
wherein the presentation unit is configured to present the first term represented by at least the comparison image with the highest similarity degree.

2. A proofreading system comprising:
a dividing unit, an appearance frequency obtaining unit, an image generation unit, a similarity degree obtaining unit, a model arithmetic unit, and a presentation unit,
wherein the dividing unit is configured to divide a sentence included in a comparison document into a plurality of first terms, and divide a sentence included in a designated document into a plurality of second terms,
wherein the appearance frequency obtaining unit is configured to obtain an appearance frequency of each of the plurality of second terms in the comparison document,
wherein the image generation unit is configured to image each of the plurality of first terms to obtain a plurality of comparison images,
wherein the image generation unit is configured to image the second term with the appearance frequency lower than or equal to a first threshold value to obtain a verification image,
wherein the similarity degree obtaining unit is configured to obtain similarity degrees between the verification image and each of the plurality of comparison images,
wherein the model arithmetic unit is configured to obtain a probability that the first term represented by the comparison image with the similarity degree greater than or equal to a second threshold value is substituted for the second term represented by the verification image, and
wherein the presentation unit is configured to present the first term with the highest probability.

3. The proofreading system according to claim 2,
wherein the model arithmetic unit is configured to perform an arithmetic operation using a machine learning model.

4. The proofreading system according to claim 3,
wherein the machine learning model is learned using the comparison document.

5. The proofreading system according to claim 3,
wherein the machine learning model is a neural network model.

6. A proofreading system comprising:
a dividing unit, an appearance frequency obtaining unit, an image generation unit, a model arithmetic unit, and a presentation unit,
wherein the dividing unit is configured to divide a sentence included in a comparison document into a plurality of first terms, and divide a sentence included in a designated document into a plurality of second terms,
wherein the appearance frequency obtaining unit is configured to obtain an appearance frequency of each of the plurality of second terms in the comparison document,
wherein the image generation unit is configured to image each of the plurality of first terms to obtain a plurality of comparison images,
wherein the image generation unit is configured to image the second term with the appearance frequency lower than or equal to a first threshold value to obtain a verification image,
wherein the model arithmetic unit is configured to infer a term represented by the verification image, and
wherein the presentation unit is configured to present a result of the inference.

7. The proofreading system according to claim 6,
wherein the model arithmetic unit is configured to perform an arithmetic operation using a machine learning model.

8. The proofreading system according to claim 7,
wherein the machine learning model is learned using the plurality of comparison images.

9.-10. (canceled)

11. The proofreading system according to claim 7,
wherein the machine learning model is a neural network model.

12. The proofreading system according to claim 1,
wherein the presentation unit comprises a display device or a speaker.

13.-24. (canceled)

25. The proofreading system according to claim 2, wherein the presentation unit comprises a display device or a speaker.

26. The proofreading system according to claim 6, wherein the presentation unit comprises a display device or a speaker.
